(19) United States
(12) Patent Application Publication
(10) Pub. No.: US 2017/0120286 A1
(43) Pub. Date: May 4, 2017

(54) WATER FOUNTAIN

(71) Applicant: Matthias Kestler, Würzburg (DE)

(72) Inventor: Matthias Kestler, Würzburg (DE)

(21) Appl. No.: 15/310,510

(22) PCT Filed: May 11, 2015
(86) PCT No.: PCT/DE2015/100191

§ 371 Date: Nov. 11, 2016

(30) Foreign Application Priority Data
May 12, 2014 (DE) 10 2014 106 670.7

(51) Int. Cl. B05B 17/08; B05B 15/08; B05B 9/04

(52) U.S. Cl. CPC B05B 17/08; B05B 9/0403; B05B 15/08

(57) ABSTRACT

The invention relates to a device for ejecting a liquid, comprising a base segment, a central segment which is mounted on the base segment in a pivotal manner about a first pivot axis, an end segment which is mounted on the central segment in a pivotal manner about a second pivot axis (ignition) that is arranged at an angle to the first pivot axis and which comprises a nozzle portion for dispensing the liquid, said nozzle portion being radially spaced from the second pivot axis, and a supply system for the liquid, said supply system being connected to the nozzle portion. The aim of the invention is to provide measures by means of which negative effects of forces reacting to a device for ejecting a liquid are reduced in the device. According to the invention, this is achieved in that the supply system comprises two end lines which open into the nozzle portion from different directions.

### CROSS-REFERENCE TO RELATED APPLICATION

This Application is a Section 371 National Stage Application of International Application No. PCT/DE2015/100191, filed 11 May 2015 and published as WO 2015/172768 A1, on 19 Nov. 2015, in German, the contents of which are hereby incorporated by reference in their entirety.

The invention relates to a device for spraying a liquid, in particular a water feature. The invention further relates to a pivoting unit for such a device.

### BACKGROUND

In the prior art, it is known, for example for water features at lakes and fountains, to generate water jets or fountains with different orientations. A nozzle that serves for spraying the water is here pivoted about at least one pivot axis, as a result of which different emergence directions of the water can be determined. In the prior art, corresponding devices are known in which a nozzle can be pivoted around two axes that are usually perpendicular to one another. In this manner, the water jet can be emitted in arbitrary directions at least within a particular spatial angular segment. In these devices with two-dimensional pivotability, a feed line from a liquid reservoir is led as far as the nozzle, the feed line being normally pressurised by means of a pump. The pressures arising thereby are typically in the range from 5 to 10 bar, considerable forces consequently occurring within the line.

While leak-tightness of the line at these pressures can be readily assured, because of the leading of the feed line, non-uniform force effects may occur. These originate from the fact that it is not static provision of a pressurized medium that is involved, but that said medium is dynamically led through the line, with each change of direction of the liquid generating a corresponding counterforce on line. The forces on the line resulting thereby as well as the components connected thereto can lead to a deformation. This may be short term and, for example, lead to the liquid jet deviating from intended direction. However, there may also be a permanent bending of components or even a fracture caused by material fatigue. This can of course be counteracted by using more robust components, which, however, leads to increased material outlay and higher costs.

### SUMMARY

Against the above described, it is the object of the present invention to propose measures by means of which, in a device for spraying a liquid, the negative effects of forces reacting on the device, are reduced.

The object is achieved according to the invention by means of a device with the features of claim 1, as well as by means of a pivoting unit with the features of claim 11.

According to the invention, a device for spraying a liquid, in particular water feature, is provided. As liquid, in particular water, however, for example for fire effects, a flammable substance, for example isopropanol, can be provided. Primarily a use for optical effects, for example in the case of water features or fountains, is provided, however use on extinguisher systems or extinguisher vehicles is also conceivable. To permit an orientation of the liquid jet in various directions, the device comprise three segments. First, a basic is provided, which may be disposed, for example, in a stationary manner on the base. However, it is also conceivable that the basic segment in turn is disposed on a type of turntable or the like. Furthermore, a central segment is provided, which is mounted on the basic segment so as to be pivotable about a first pivot axis. Finally, device comprises an end segment that is mounted on the central segment so as to be pivotable about a second pivot angle that is disposed at an angle to the first pivot axis. The first and second pivot axes are thus not parallel to one another. Each of the segments is preferably designed such that it is rigid. The end comprises a nozzle portion for emission of the liquid, the nozzle portion being radially spaced from the second pivot axis. The nozzle portion here comprises either a nozzle that is provided directly for spraying the liquid and may possibly be very simple in design, or at least a connection for such a nozzle. Furthermore, the device comprises a feed line system for the liquid, to which the nozzle is connected. Here, “connected” of course means that liquid from the feed system can pass into the nozzle portion. The feed system here does not need to extend completely as far as a liquid reservoir; additional feed components can be provided for this purpose, which this sense are not regarded as part of the device according to the invention. At least parts of the feed system can extend within the aforementioned segments or be a part thereof.

According to the invention, the feed system comprises two end lines, which open into the nozzle portion from different directions. The aforementioned end line thus forms part of the feed system, which is located directly upstream of the nozzle portion. Here, they first progress separately from one another and are merged together at nozzle portion. This may be, for example, in the manner of a T-piece or a Y-piece. That is to say, in contrast to the prior art, in which the nozzle is ultimately fed through an individual feed line, two feed-line portions are used within the scope of the invention, at least in the region of the actual nozzle, which open from different directions. This provides different advantages. On one hand, it is possible to position the nozzle portion in a suitable manner with respect to the second pivot axis such that the actual reaction of the emerging water jet can be readily absorbed. In the prior art, the actual outlet nozzle is in many cases located in an end region of a pivot axis, as a result of which the reaction generates undesirable flexural moments. In contrast thereto, in the solution according to the invention, the nozzle portion can to a certain extent be located between the aforementioned end lines, as a result of which resulting reaction forces can be significantly better absorbed. Furthermore, forces that occur within end lines due to diversion of the liquid can mutually compensate one another, so that, although the end lines as such are loaded, the cannot be transferred to other components of the device.

The orientation of the first and second pivot axis can be chosen in different ways. A typical orientation that of course depends on the installation of the base segment, consists in the first pivot axis being oriented horizontally. As regards the orientation of the pivot axes with respect to one another, it is preferred to dispose the first and second pivot axes perpendicular to one another. By this means, in a particularly simple manner, an orientation of the liquid jet in various spatial angular directions can be achieved.

According to a further advantageous embodiment of the invention, the first and second pivot axes intersect. This thus means that the first and second pivot axes extend in one plane. They thereby intersect at a point that lies within the central segment. An advantage of this embodiment is that forces occurring at the second pivot axis normally cannot lead to torques with respect to the first pivot axis, and vice versa. This further contributes to stabilization of the adjusted position of the nozzle portion.

It is furthermore preferred that the nozzle portion is arranged such that the central segment is located in a backward extension of an emission direction, which is predetermined by the nozzle portion, of the liquid. For the emission, that is to say for the spraying of the liquid, a force retroacts on the nozzle portion according to the principle of reaction. The direction thereof is determined by the backward extension of the emission direction, which in turn is determined by the geometry of the nozzle portion. If, as described, the nozzle portion is arranged such that the central segment is located in the direction of this reaction force, this reaction force effects no, or at most a slight, torque in the region of the central segment. Since the central segment can to a certain extent be regarded as the “core” of the invention, and is connected to both pivot axes, with the aforementioned embodiment, the reaction force is normally absorbed such that no or hardly any undesirable loads as a result of torques occur.

Advantageously the device comprises a first motor unit for pivoting the central segment and a second motor unit for pivoting the end segment. Here, it is particularly advantageous if the first and second motor unit are disposed on the central segment opposite one another with respect to the first pivot axis. That is to say the first motor units are disposed on the central segment and typically form a part thereof, or are firmly connected thereto. On pivoting of the central segment about the pivot axis, a positional change of the motor units occurs, which potentially could lead to undesirable torques because of the weight of the motor units. By the fact that the motor units are disposed on opposite sides of the first pivot axes, however, the resulting torques are (at least partly) cancelled out, for which reason the support of the first rotary axis by the base element can be designed to be simpler, or weaker.

Preferably at least one of the rotary axes can be designed as a hollow axis, which serves as a line for the liquid. Thereby, end connections can be provided, for example at the ends of the second rotary axis, to which the two end conduits are connected. The aforementioned end connections extend coaxially to the second rotary axis. In a typical embodiment, the end lines at first extend in an axial extension of the second rotary axis, then extend radially away from the second axis of rotation and are then led toward one another in an axial direction in order to open into the nozzle portion.

According to one embodiment, two basic lines of the feed system open at their ends into the first pivot axis, which is designed as a hollow axis, the first pivot axis connecting within the central segment with the second pivot axis, which is designed as a hollow axis, and two end lines being connected at their ends to the second pivot axis. Thereby, the basic segment can have two basic connections, which are oriented coaxially to the first pivot axis and which serve for connection of the basic lines. In this embodiment, in particular the and second pivot axes can intersect, so that the two hollow axes in total form a cross-shaped structure. Hereby, in the intersection a diagonal partition wall may be provided, as a result of which one of the line that is provided by the first pivot axis is in connection with precisely one half of the line that is provided by the second pivot Put differently, in this case a basic line would be in connection with precisely one end line. An assignment of this kind, however, is not necessary.

The end lines are necessarily spaced from one another at certain regions. It is advantageously possible for the motor unit to be disposed between the end lines. Correspondingly, with the presence of two basic lines that are spaced from one another, the first motor unit may be disposed between the basic lines. By means of the aforementioned measures, the device overall may be designed to be more compact. It goes without saying that the arrangement as described may possibly only exist in a particular pivot state about the first or second pivot axis. At any rate, this means that the particular motor unit, in the case of a pivot operation, does not collide with the particular lines but can be passed through between them.

The above-described compensation of occurring forces can be improved by designing the end lines so as to be symmetrical to a plane that runs through the first pivot axis. Because of the symmetrical design with respect to the first pivot axis, no undesirable torques can act on it since corresponding forces within the end lines cancel each other out. Likewise an improvement can be achieved by designing the end lines along a plane that runs through the second pivot axis. This statement is of course not to be interpreted in the strictly geometrical sense, since the end lines must have a certain expansion that is not restricted to one plane. It is thereby intended that the direction of the profile of the end lines remains in one plane, which includes the second pivot axis. It thereby goes without saying that no torques can occur on the second pivot axis.

In a corresponding manner, it is preferred that the basic lines are designed so as to be symmetrical to a plane that runs through the second pivot axis and/or along a plane that runs through the first axis. The positive effects that thereby result regarding the occurring torques correspond to the aforementioned description of the end lines.

Furthermore, a pivoting unit for a device for spraying a liquid is provided according to the invention. The pivoting unit comprises a basic segment, a central segment and an end segment. The central segment is mounted on the basic segment so as to be pivotable about a first pivot axis. The end segment is mounted on the central segment so as to be pivotable about a second pivot axis that is disposed at an angle to the first pivot axis. It has two end connections, which are provided for connection of two end lines of a feed-line system that lead to a nozzle portion. The pivoting unit is additionally connected to at least one further connection for joining to a liquid reservoir, which is connected to the end connections. In particular, two basic connections may be present, which are provided for connection to the liquid reservoir via two basic lines.

The two end connections are preferably disposed so as to be coaxial to the second pivot axis, and the two basic connections are disposed so as to be coaxial to the first pivot axis. In this case, the two pivot axes are designed as hollow axes, and the end connections are in connection with the basic connections in the interior of the central segment.

Further preferred embodiments of the pivoting unit correspond to the above-described embodiments of the device according to the invention and are therefore not explained again.

### BRIEF DESCRIPTION OF THE DRAWINGS

Details of the invention are explained below with reference to two exemplary embodiments with reference to the figures, wherein,

FIG. 1 shows a perspective view of a first embodiment of a device according to the invention

FIG. 2 shows a perspective view of a pivoting unit of a second embodiment of a device according to the invention

FIG. 3 shows a first side view of the pivoting unit from FIG. 2, and

FIG. 4 shows a second side view of the pivoting unit from FIG. 2.

### DETAILED DESCRIPTION OF ILLUSTRATIVE EMBODIMENTS

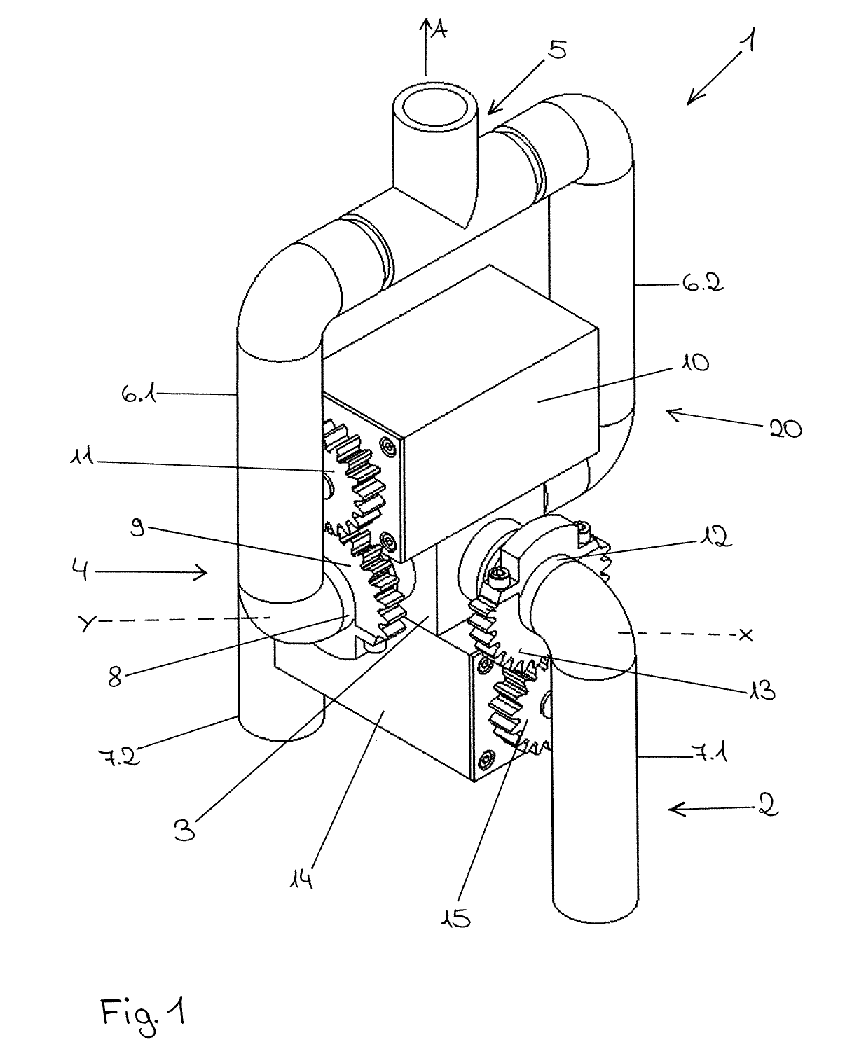

FIG. 1 shows a perspective view of a first embodiment of a device 1 according to the invention, which is provided for generation of water fountains. The device 1 comprises a basic segment 2, a central segment 3 and an end segment 4. The basic element 2 comprises two basic lines 7.1, 7.2 of a feed system, which is connected to a water reservoir (not shown here), and which is pressurised there by means of a pump (which is also not shown): The basic lines first extend vertically and then bend at an angle of 90° to the horizontal, where they are connected to basic connections 12. The basic connections 12 are part of a first pivot axis X, which is embodied as a hollow axis, and of which the central segment 3 is pivotable with respect to the basic element 2. The pivot operation can be controlled via a motor unit 14 with a gear wheel 15, wherein the gear wheel 15 engages with a gear wheel 13, which is mounted coaxially on a basic connection 12 and is connected non-rotatably thereto. The end segment 4 is supported via a second pivot axis Y so as to be pivotable with respect to the central segment 3. The second pivot axis Y is offset by 90° with respect to the first pivot axis X, and intersects the latter within the central segment 3. The pivotability of the end segment 4 with respect to the central segment 3 is in turn controlled via a motor unit 10, which has a gear wheel 11. The latter engages with a gear wheel 9, which is mounted non-rotatably on an end connection 8, which extends coaxially to the second pivot axis Y.

From the end connection 8, starts a first end line 6.1 starts out, first extends horizontally in the direction of the second pivot axis Y then bends upwards by 90° and finally bends again through 90° and guided in a direction parallel to the pivot axis Y. On the opposite side of the central segment 3, there is a second end line 6.2 which is designed so as to be symmetrical thereto and also starts from an end connection. The two end lines 6.1, 6.2 are merged together from opposite directions at a nozzle portion 5, which is designed as a T-T-piece. The nozzle portion 5, through which the water is ejected in operating station in an ejection direction A, is shown here without a special nozzle. Of course, such a nozzle can be provided.

The central segment 3, with, disposed thereon, the basic connections 12 and end connections 8, forms a pivoting unit 20, which can be regarded as the core portion of the device 1. The basic lines 7.1, 7.2, end lines 6.1, 6.2 as well as the nozzle portion 5 may be basically formed from commercially available elements that are known in the prior art.

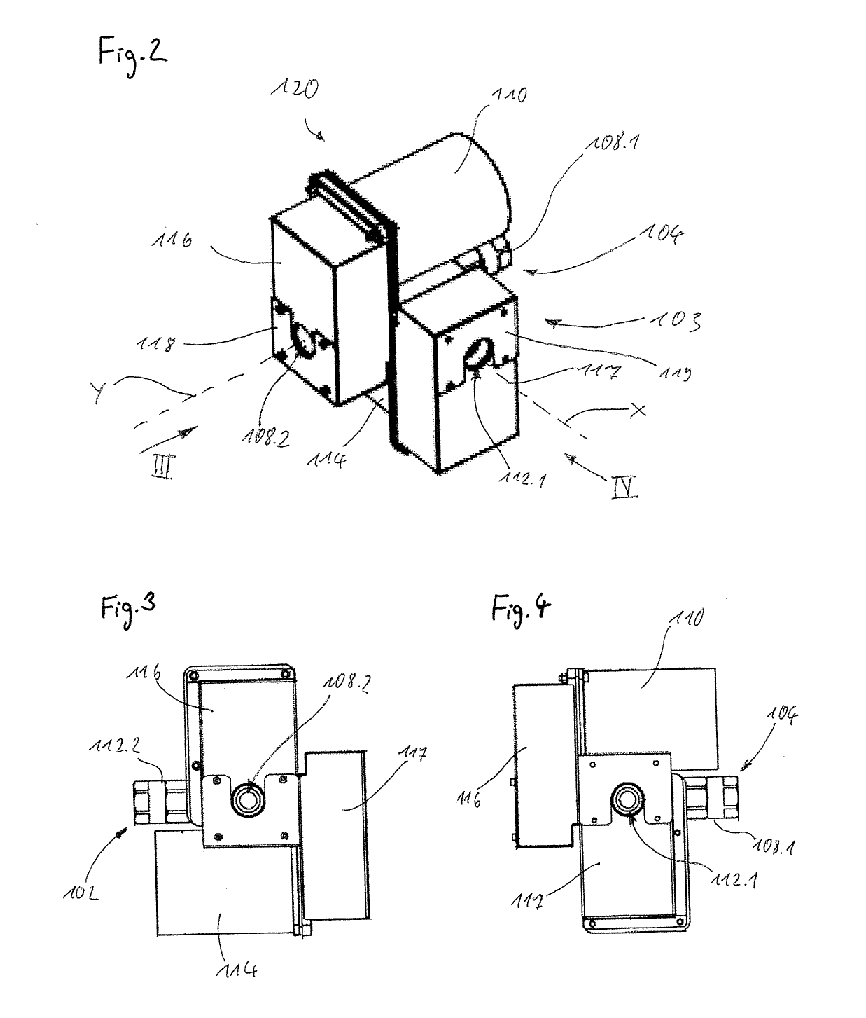

As becomes clear from FIG. 1, the two basic lines 7.1, 7.2 extend in a plane with the first pivot axis X and are symmetrical to a plane that includes the second pivot axis Y. Furthermore, the two end lines 6.1, 6.2 extend in a plane with the second pivot axis Y and are symmetrical to a plane that includes the pivot axis X. If, during operation of the device 1, pressurised water flows through the aforementioned lines 6.1, 6.2, 7.1, 7.2, counterforces occur at the points at which a diversion of the water flow takes place. Because of the described symmetrical arrangement of the various lines, however, no resulting torques occur at the pivot axes X, Y. Furthermore, the two motor units 10, 14 are arranged on opposite sides of the first pivot axis X, such that, during pivoting, the torques caused by their weight essentially cancel one another out. The entire device 1 is thus (almost) in equilibrium both statically and dynamically, and consequently its components can be designed comparatively lightweight, and only slight deformation occurs in operation. It is also advantageous that the central segment 3, in which the pivot axes X, Y cross, is located in a backward extension of the ejection direction A. The reaction force of the ejected water thus acts toward the central segment 3, and consequently is optimally absorbed by it, and does not lead to any torques on the pivotability about each of the axes X, Y is fundamentally 180°, 90° in each direction with respect to the central position shown in FIG. 1, wherein, depending on the pivot state about the other axis each case the full pivot range may possibly not be exploitable, since the end lines 6.1, 6.2 strike against the basic lines 7.1, 7.2. however, with the illustrated device 1, it is possible to achieve any (two-dimensional) angle range within a half-space. FIGS. 2-4 show a pivoting unit 120 in a further embodiment of the present invention. Here, FIG. 3 shows a side view of the perspective marked III in FIG. 2, and FIG. 4 shows a side view of the perspective marked IV. The illustrated pivoting unit 120 can be used with basic lines and end lines of a feed system, as well as with a nozzle portion, which correspond to the elements shown in FIG. 1. The pivoting unit 120 comprises a central segment 103, which, with respect to a basic segment 102, is pivotable about a first pivot axis X and, on one end segment 104, is pivotable about a second pivot axis Y. The central segment 103 has in a corresponding manner, as in the exemplary embodiment shown in FIG. 1, two motor units 110, 114, which are disposed opposite with respect to the second pivot axis Y. Here, too, the motor unit 110 used for pivoting with respect to the second pivot axis Y has two gear wheels on an end connection 108.2, to which an end line of the feed system can be connected. Another end connection 108.1 is present on an opposite side of the central segment 103.

The end connection 108.2 can be seen only partially in FIGS. 2-4, since it is disposed, together with the aforementioned gear wheels, in a gear housing 116. The gear housing 116 serves to protect the internal components against water, since the available pivoting unit 120 is intended for submerged use. To permit better access to the connection 108.2, a closure plate 118 is provided on the gear 116, which can be removed by releasing screw connections. In a corresponding manner, a basic connection 112.1 of the basic 102 is disposed together with the corresponding gear wheels in a housing 117, which has a corresponding closure plate 119. Here, too, a further basic connection 112.2 is provided on an opposite side of central segment 103. By means of the connections 112.1, 112.2, lines of a feed system can be connected in an analogous manner to that shown in FIG. 1. The internal structure of the central segment 103 corresponds to that shown in FIG. 1, that is to say that the connections 112.1, 112.2 of the basic element 102 is in connection with the connections 108.1, 108.2 of the end segment 104.

1. Device for spraying a liquid, comprising
a base segment,
a central segment which is mounted on the base segment in a pivotal manner about a first pivot axis,
an end segment which is mounted on the central segment in a pivotal manner about a second pivot axis that is arranged at an angle to the first pivot axis and which comprises a nozzle portion for dispensing the liquid, said nozzle portion being radially spaced from the second pivot axis, and
a feed system for the liquid, said feed system being connected to the nozzle portion,
wherein the feed system comprises two end lines which open into the nozzle portion from different directions.

2. Device according to claim 1, characterized in that the first and second pivot axes are perpendicular to one another.

3. Device according to claim 1, characterized in that the first and second pivot axes intersect one another.

4. Device according to claim 1, characterized in that the nozzle portion is arranged such that the central segment is located in a backward extension of an emission direction of the liquid, which is predetermined by the nozzle portion.

5. Device according to claim 1, characterized by
a first motor unit for pivoting the centre segment as well as
a second motor unit for pivoting the end segment,
the first and second motor units being disposed opposite one another with respect to the first pivot axis on the central segment.

6. Device according to claim 1, characterized in that at least one of the rotational axes (X, Y) is designed as a hollow axis, which serves as a line for the liquid.

7. Device according to claim 6, characterized in that two basic lines of the feed system open at their ends into the first pivot axis, which is designed as a hollow axis, the first pivot axis connecting within the centre segment with the second pivot axis, which is designed as a hollow axis, and the two end lines being connected at their ends to the second pivot axis.

8. Device according to claim 5, characterized in that the first motor unit is disposed between the base lines and the second motor unit is disposed between the end lines.

9. Device according to claim 1, characterized in that the end lines designed so as to be symmetrical to a plane that runs through the first pivot axis and along a plane that runs through the second pivot axis.

10. Device according to claim 1, characterized in that the basic lines are designed so as to be symmetrical to a plane that runs through the second pivot axis and along a plane that runs through the first pivot axis.

11. Pivoting unit for a device for spraying a liquid, comprising
a basic segment,
a central segment which is mounted on the basic segment a pivotal manner about a first pivot axis,
an end segment is mounted on the central segment such that it is pivotal about a second pivot axis that is arranged at an angle to the first pivot axis and which comprises two end connections, which are intended for connection of two end lines of a feed system, which lead to a nozzle portion
wherein the pivoting unit is additionally connected to at least one further connection for connection to a liquid reservoir, which is connected to the end connections.
